(19) United States
(12) Patent Application Publication
(10) Pub. No.: US 2008/0303449 A1
(43) Pub. Date: Dec. 11, 2008

(54) COLD CATHODE FLUORESCENT LIGHTING DISCHARGE TUBE DEVICE

(75) Inventor: Toru Ashikaga, Saitama (JP)

Correspondence Address: BACHMAN & LAPOINTE, P.C., 900 CHAPEL STREET, SUITE 1201, NEW HAVEN, CT, 06510, US

(73) Assignee: SANKEN ELECTRIC CO., LTD., Saitama (JP)

(21) Appl. No.: 12/122,756

(22) Filed: May 19, 2008

(30) Foreign Application Priority Data
Jun. 7, 2007 (JP) 2007-151173

(51) Int. Cl. H05B 37/02

(52) U.S. Cl. 315/224

(57) ABSTRACT

A cold cathode fluorescent lighting discharge tube device is provided which comprises a first ballast element 21, 31 connected between each first end 3a of a pair (i) of discharge tubes 3 and a first output end 1a of an inverter 1, a second ballast element 22, 32 connected between a second terminal 3b of one of the pair (i) of discharge tubes 3 and a second output terminal 1b of inverter 1, and a third ballast element 23, 33 connected between second terminal 3b of the other of the pair of discharge tubes 3 and second output terminal 1b of inverter 1. This circuit configuration allows independent operation of second and third ballast elements 22, 23 while improving uneven brightness along discharge tube 3, and can apply a trigger voltage of sufficient level to unlit discharge tube 3 without providing ballast elements of double in number of plural discharge tubes 3.

### TECHNICAL FIELD

This invention relates to a cold cathode fluorescent lighting discharge tube device provided with a reduced number of ballast elements.

### BACKGROUND OF THE INVENTION

A cold cathode fluorescent lighting discharge tube device (CCFL) is also called a cold cathode tube or a fluorescent tube which can give out light when an inverter applies to it AC voltage from hundreds to thousands volts with frequency typically less than 100 kilohertz. As shown in FIG. 8, a prior art cold cathode tube comprises an inverter 1 connected to a DC power source 2 for supplying AC power to a discharge tube 3. Inverter 1 comprises an AC power generator 4 connected to DC power source 2, and a voltage converter 5 for converting AC power from generator 4 into a different voltage level and applying the converted AC power to discharge tube 3. Generator 4 comprises first and second MOS-FETs 6 and 7 respectively as first and second switching elements connected in series to DC power source 2, and a capacitor 8 one end of which is connected to a junction between first and second MOS-FETs 6 and 7. Voltage converter 5 comprises a transformer 9 which has a primary winding 9a connected between the other end of capacitor 8 and DC power source 2 and in parallel to second MOS-FET 7, and a secondary winding 9b connected in parallel to discharge tube 3. Not shown in FIG. 8, but transformer 9 involves a leakage inductance between primary and secondary windings 9a and 9b.

In operation, first and second MOS-FETs 6 and 7 are alternately turned on and off. For example, when first MOS-FET 6 is turned on under the off condition of second MOS-FET 7, electric current flows from DC power source 2, first MOS-FET 6, capacitor 8 and primary winding 9a to DC power source 2 to electrically charge capacitor 8, and at the same time, lighting current runs in one way from secondary winding 9b through discharge tube 3. Adversely, when second MOS-FET 7 is turned on under the off condition of first MOS-FET 6, energy accumulated in capacitor 8 is released by discharge current sent from capacitor 8 through second MOS-FET 7 and primary winding 9a to capacitor 8. Accordingly, another lighting current flows in the adverse direction from secondary winding 9b through discharge tube 3 which is therefore turned on by AC power with the voltage of desirable level and frequency converted through inverter 1. FIG. 9 illustrates a load circuit which comprises a discharge tube 3 and a ballast capacitor 10 as a ballast element or current limiter connected in series to discharge tube 3 to stabilize tube current through discharge tube 3 by a combined feature of positively resistive composite impedance by ballast capacitor 10 and negatively resistive characteristics by discharge tube 3.

For recent years, technological development has been advanced to adopt longer discharge tubes and simultaneously brighten multiple discharge tubes for associated liquid crystal displays getting larger in size so that the market has been requesting an inverter for producing output voltages of higher level, and in particular, a single inverter which has a multiple lighting circuit for coincidently turning on a plurality of discharge tubes. FIG. 10 shows an example of a cold cathode fluorescent lighting discharge tube device provided with an inverter 1 as a multiple lighting circuit which has first and second output terminals 1a and 1b connected to two discharge tubes 13 and 14 in parallel relation to each other. FIG. 11 illustrates a graph showing a tube current to voltage characteristics in each of discharge tubes 13 and 14. As understood from FIG. 11, when AC power with effective voltage of 1300 volts is applied to discharge tubes 13, 14, they start discharging electricity, and inverter 1 needs to continuously keep applying an effective voltage of 1000 volts to maintain effective current of 5 milliamperes through discharge tubes 13, 14. FIG. 11 also makes it clear that each of discharge tubes 13 and 14 indicates its negative resistance characteristics of the reducing voltage value with increase of the electric current value after the lighting. In another aspect, after effective voltage of 1300 volts is simultaneously impressed on both of discharge tubes 13 and 14, one of them starts lighting earlier than the other due to various parameters such as difference in inherent property of discharge tubes 13 and 14 and ambient temperature etc., and therefore, they cannot start lighting in unison together. This means that discharge tubes 13 and 14 demonstrate the different point in time for lighting commencement after application of voltage thereto. For example, the cold cathode fluorescent lighting discharge tube device shown in FIG. 10 comprises inverter 1 and a series circuit connected between first and second output terminals 1a and 1b. The series circuit comprises a ballast capacitor 10 and first and second discharge tubes 13 and 14 connected in series to ballast capacitor 10 and in parallel to each other. When AC power with effective voltage of 1300 volts is concurrently supplied to first and second discharge tubes 13 and 14, if first discharge tube 13 happens to first lighten under the unlit condition of second discharge tube 14, electric current of for example 7 milliamperes flows through first discharge tube 13 having the negative resistance characteristics while effective voltage is lowered to effective voltage of 940 volts. In this case, unlit second discharge tube 14 is supposed to have infinite impedance in the opened or deactivated condition whereas lighting is provided by first discharge tube 13 connected in parallel to second discharge tube 14. Accordingly, reduced effective voltage of 940 volts, not 1300 volts is applied to both ends of inactive second discharge tube 14 which is therefore kept in the unlit condition. In this view, as shown in FIG. 12, a multiple lighting discharge tube device must have ballast capacitors 10 each connected to two discharge tubes 13 and 14 to accelerate lighting of inactive second discharge tube 14. Although lowered voltage is applied to first discharge tube 13 after lighting, ballast capacitors 10 serve to supply unchanged output voltage from inverter 1 onto inactive second discharge tube 14 because ballast capacitors 10 maintain voltage of high level necessary and enough to trigger lightening commencement for second discharge tube 14. Such a multiple lighting discharge tube device is disclosed by for example Japanese Patent Disclosure No. 2001-244094 by T. Yuda et al.

With the longer discharge tube 3, the higher AC voltage must be generated by inverter 1 to turn discharge tube 3, and therefore, increased voltage is applied to each electric element in inverter 1. FIG. 13 shows a circuit configuration of a transformer 9 which has first and second secondary windings 9b and 9c connected to each other through a center tap connected to a chassis or ground or a negative terminal of power source to divide the output from inverter 1 into two split outputs and thereby alleviate voltage burden applied on secondary windings 9b and 9c. In FIG. 13, a division line 11 connects between the center tap or junction of first and second secondary windings 9b and 9c and ground to connect first and second secondary windings 9b and 9c in the opposite phase. Instead of such a center tap structure, a plurality of inverters may be used to produce outputs of the adverse phase to each other.

As understood from FIG. 14, generally leak currents 17 flow through a parasitic capacitance 16 shown by dotted lines formed between a discharge tube 3 and a metallic chassis 12 to which discharge tube 3 is attached. When a single ballast capacitor 10 shown in FIG. 13 is connected in series to discharge tube 3, ballast capacitor 10 induces a voltage drop at one of both ends of discharge tube 3 which are applied voltages of different levels at the opposite ends so that leak current 17 flows from discharge tube 3 to chassis 12 in the asymmetric pattern of leak current 17 lengthwise of discharge tube 3. Leak current 17 actually produced in the circuit shown in FIG. 13 flows through parasitic capacitances 16 as shown by arrows of different length in FIG. 14 wherein the length of these arrows indicates magnitude of leak current 17. It should be noted that no leak current 17 passes through parasitic capacitance 16 without an attendant arrow because this parasitic capacitance 16 is at a ground potential. Uneven amount of leak current 17 along a length of discharge tube 3 disadvantageously causes non-uniform or unequal brightness in the longitudinal direction of discharge tube 3, and with the longer discharge tube 3, the greater difference in voltage is applied at the opposite ends of discharge tube 3 with the greater difference in brightness lengthwise of discharge tube 3. Accordingly, when ballast capacitors 10 are connected to opposite ends of discharge tube 3 as shown in FIGS. 15 and 16, voltage of same level can be applied to both terminals of discharge tube 3, and a substantially central portion of discharge tube 3 comes to ground potential during lightening operation of discharge tube 3 so that both ends of discharge tube 3 have substantially equal amount of leak current 17 and substantially same level of brightness. FIG. 17 indicates a prior art cold cathode fluorescent discharge tube device of multiple lighting which can have longer multiple discharge tubes 13 and 14 connected to first and second output terminals 1a and 1b of inverter 1 each connected in series through ballast capacitor 10.

In this way, prior art cold cathode fluorescent tube devices require a plurality of discharge tubes 13 and 14 and ballast capacitors twice the number of discharge tubes 13 and 14 as shown in FIG. 17 when the single inverter 1 produces high output voltage to simultaneously lighten discharge tubes 13 and 14. FIG. 18 shows an example of cold cathode fluorescent tube devices which comprises ballast coils 30 connected in series to discharge tubes 13 and 14 in lieu of ballast capacitors 10 indicated in FIG. 17. Similarly to the device shown in FIG. 17, ballast coils 30 in the device of FIG. 18 also can maintain voltage of high level necessary and enough to trigger lightening commencement of second discharge tube 14 even though lowered voltage is applied to lightening discharge tube 13. In this case, the tube device again requires ballast coils twice the number of discharge tubes 13 and 14.

Accordingly, the present invention is to provide a cold cathode fluorescent lighting discharge tube device with a reduced number of ballast elements.

### SUMMARY OF THE INVENTION

The cold cathode fluorescent lighting discharge tube device according to the present invention comprises at least a pair (i) of discharge tubes (3) each having first and second ends (3a, 3b), an inverter (1) for converting DC voltage from a DC power source (2) into AC voltage, the inverter (1) having first and second output terminals (1a, 1b) to apply AC voltage between first and second terminals (3a, 3b) of each discharge tube (3), a first ballast element (21, 31) connected between each first end (3a) of the pair (i) of discharge tubes (3) and first output end (1a) of inverter (1), a second ballast element (22, 32) connected between second terminal (3b) of one of the pair (i) of discharge tubes (3) and second output terminal (1b) of inverter (1), and a third ballast element (23, 33) connected between second terminal (3b) of the other of paired discharge tubes (3) and second output terminal (1b) of inverter (1). This circuit configuration allows independent operation of second and third ballast elements (22, 23) to apply a trigger voltage of sufficient level to unlit discharge tube (3) without providing ballast elements of double in number of plural discharge tubes (3).

### BRIEF DESCRIPTION OF THE DRAWINGS

The above-mentioned and other objects and advantages of the present invention will be apparent from the following description in connection with preferred embodiments shown in the accompanying drawings wherein:

FIG. 1 is an electric circuit diagram showing a first embodiment of a cold cathode fluorescent lighting discharge tube device according to the present invention;

FIG. 2 is an electric circuit diagram showing a second embodiment of the device;

FIG. 3 is an electric circuit diagram showing a third embodiment of the device;

FIG. 4 is an electric circuit diagram showing a fourth embodiment of the device;

FIG. 5 is an electric circuit diagram showing a fifth embodiment of the device;

FIG. 6 is an electric circuit diagram showing a sixth embodiment of the device;

FIG. 7 is an electric circuit diagram showing a seventh embodiment of the device;

FIG. 8 is a basic electric circuit diagram showing a prior art cold cathode fluorescent lighting discharge tube device;

FIG. 9 is an electric circuit diagram which includes a ballast capacitor connected in series to a discharge tube in the basic circuit shown in FIG. 8;

FIG. 10 is an electric circuit diagram which includes two discharge tubes and a ballast capacitor connected in series to each of the discharge tubes;

FIG. 11 is a graph showing a voltage to electric current characteristics of a discharge tube;

FIG. 12 is an electric circuit diagram which includes two discharge tubes and two ballast capacitors each connected in series to the discharge tube;

FIG. 13 is an electric circuit diagram showing a prior art cold cathode fluorescent lighting discharge tube device provided with a transformer of another type;

FIG. 14 is a schematic diagram showing a parasitic capacitance formed between the discharge tube and a chassis and uneven leak current flows running through the parasitic capacitance;

FIG. 15 is an electric circuit diagram with a pair of ballast capacitors connected to opposite ends of the discharge tube in the electric circuit shown in FIG. 13;

FIG. 16 is a schematic diagram showing a parasitic capacitance formed between the discharge tube and chassis and leak current with the amount of mirror image lengthwise of the discharge tube;

FIG. 17 is an electric circuit diagram which includes two discharge tubes and ballast capacitors at both ends of each of the discharge tubes; and

FIG. 18 is an electric circuit diagram which includes ballast coils in place of the ballast capacitors shown in FIG. 17.

### BEST MODE FOR CARRYING OUT THE INVENTION

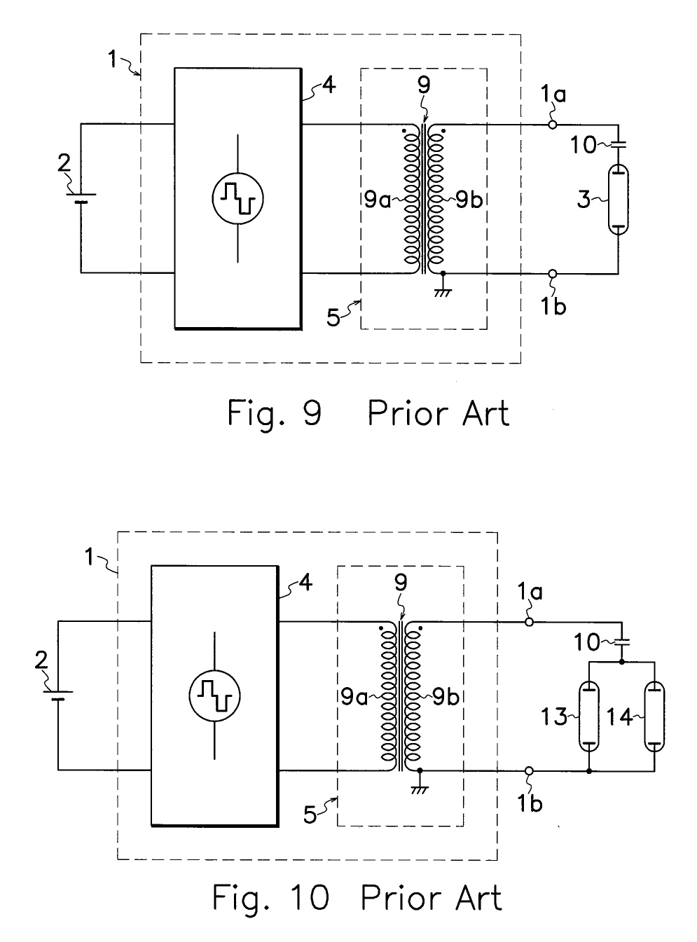

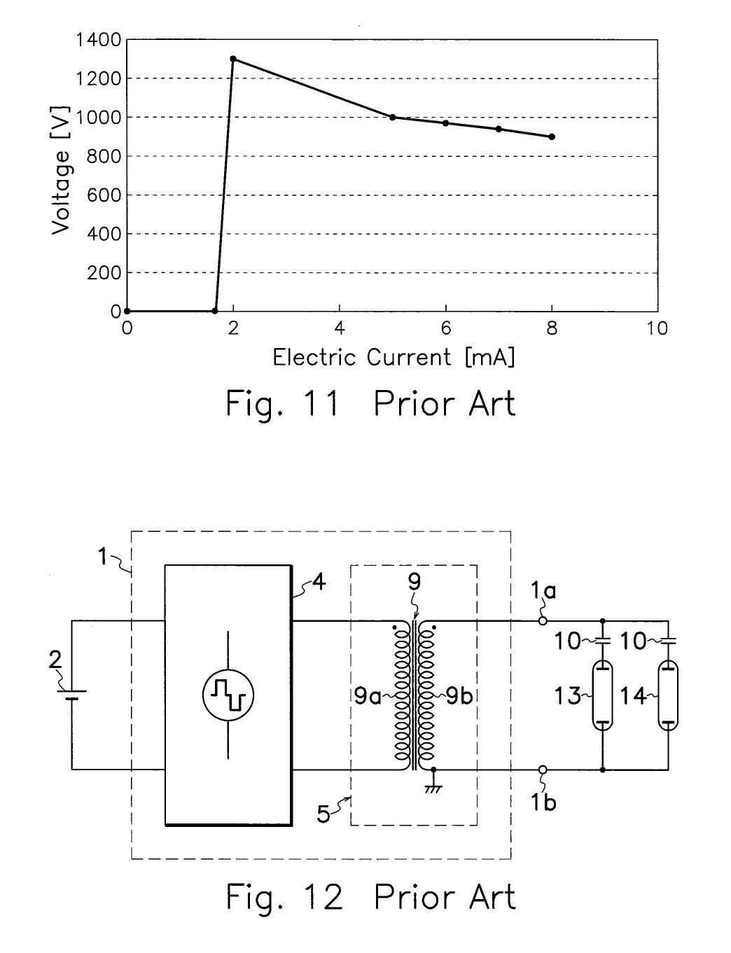

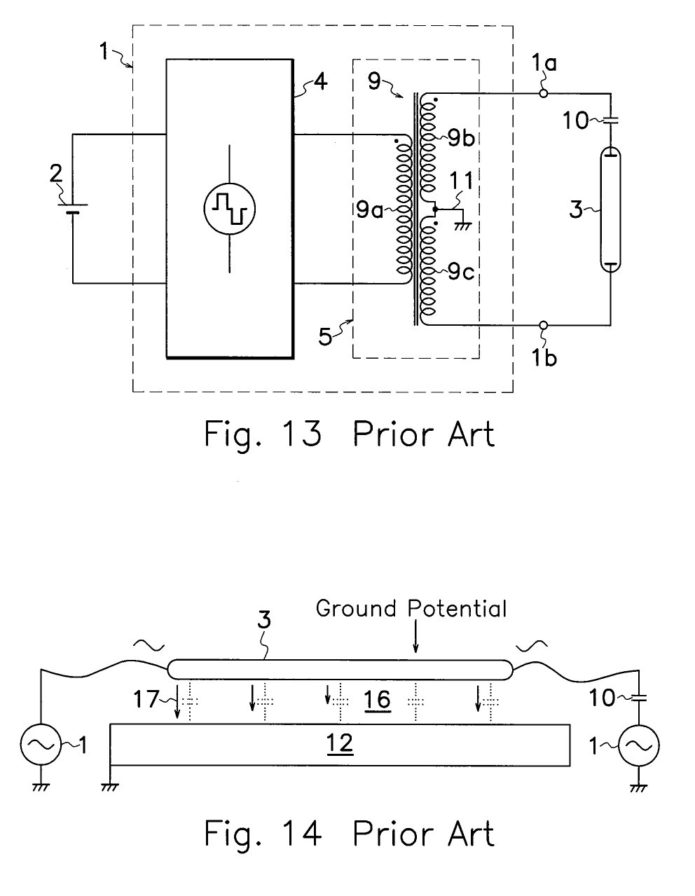

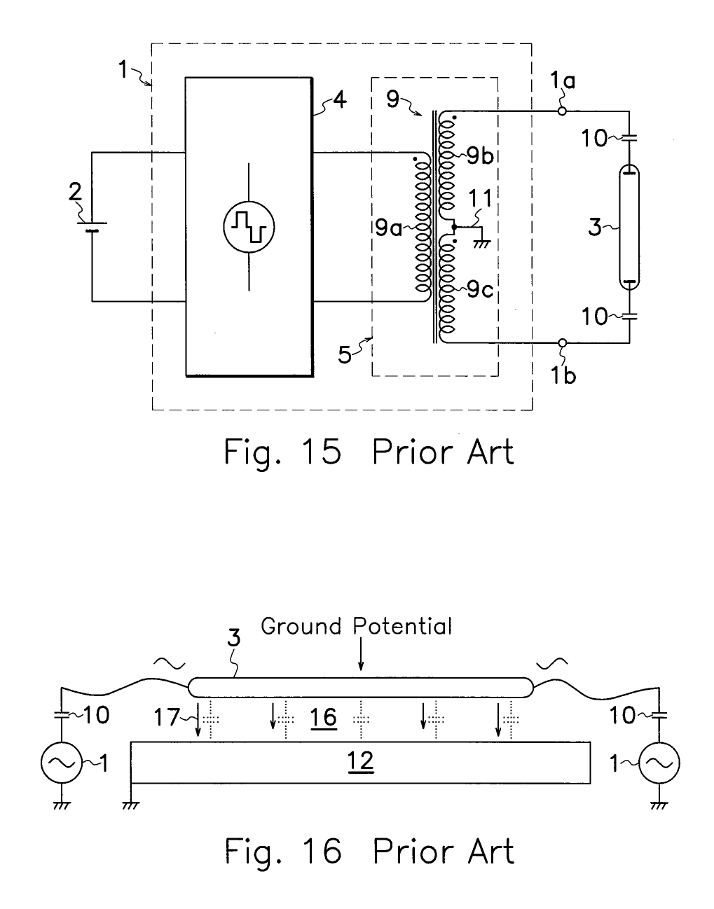

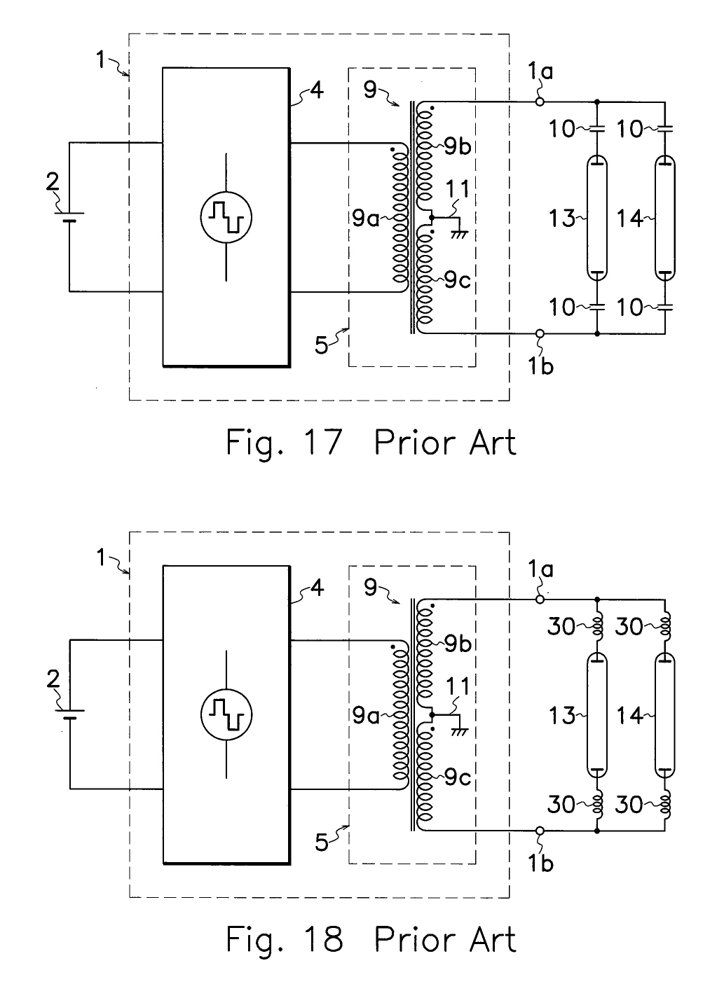

Embodiments of the cold cathode fluorescent lighting discharge tube device according to the present invention will be described hereinafter in connection with FIGS. 1 to 7 of the drawings. Same reference symbols as those shown in FIGS. 8 to 10, 12, 13, 17 and 18 are applied to similar portions in FIGS. 1 to 7, omitting description on these similar portions.

A first embodiment of the cold cathode fluorescent lighting discharge tube device according to the present invention, comprises a first ballast capacitor 21 as a first ballast element connected between each first end 3a of a pair (i) of discharge tubes 3 and a first output end 1a of an inverter 1; a second ballast capacitor 22 as a second ballast element connected between a second terminal 3b of one of the pair (i) of discharge tubes 3 and a second output terminal 1b of inverter 1; and a third ballast capacitor 23 as a third ballast element connected between second terminal 3b of the other of paired discharge tubes 3 and second output terminal 1b of inverter 1. When either of paired discharge tubes 3 is turned on, electric circuitries shown in FIG. 1 produce for example the following electric current flows and the following voltages:
Effective voltage on first secondary winding 9b: 950 volts
Effective voltage on second secondary winding 9c: 950 volts
Capacitance in first ballast capacitor 21: 40 picofarads
Effective voltage on first ballast capacitor 21: 807 volts
Effective current through each discharge tube 3: 5 milliamperes
Effective voltage on each discharge tube 3: 1000 volts
Each capacitance in second and third ballast capacitors 22 and 23: 20 picofarads
Each effective voltage in second and third ballast capacitors 22 and 23: 807 volts

On the other hand, when one of paired discharge tubes 3 is turned on under the unlit condition of the other of discharge tubes 3, electric circuitries shown in FIG. 1 produce for example the following electric current flows and the following voltages:
Effective voltage on first secondary winding 9b: 950 volts
Effective voltage on second secondary winding 9c: 950 volts
Capacitance in first ballast capacitor 21: 40 picofarads
Effective voltage on first ballast capacitor 21: 585 volts
Effective current through lighting discharge tube 3: 7 milliamperes
Effective voltage on lighting discharge tube 3: 940 volts
Effective current through unlit discharge tube 3: 0 milliamperes
Effective voltage on unlit discharge tube 3: 1510 volts
Each capacitance in second and third ballast capacitors 22 and 23: 20 picofarads
Effective voltage on one of second and third ballast capacitors 22 and 23 connected in series to lighting discharge tube 3: 807 volts
Each effective voltage on second and third ballast capacitors 22 and 23: 807 volts
Effective voltage on one of second and third ballast capacitors 22 and 23 connected in series to unlit discharge tube 3: 0 volts

Thus, unlike the above-mentioned prior art circuit with the undesirable decrease in effective voltage on unlit discharge tube 3, the typical electric circuit shown in FIG. 1 according to the present invention, does not reduce effective voltage on unlit discharge tube because effective voltage of 1510 volts is applied on unlit discharge tube 3 which would be turned on very soon later. In this way, the circuit shown in FIG. 1 allows second and third ballast capacitors 22 and 23 to operate independently from each other so that trigger voltage of sufficient level enough to start lighting can be applied on unlit discharge tube 3, while it can reduce the number of ballast capacitors 21 to 23 relative to number of discharge tubes 3. In addition, as a substantially central portion of discharge tube 3 comes down to ground potential, discharge tube 3 can shine with uniform brightness at opposite ends of discharge tube 3.

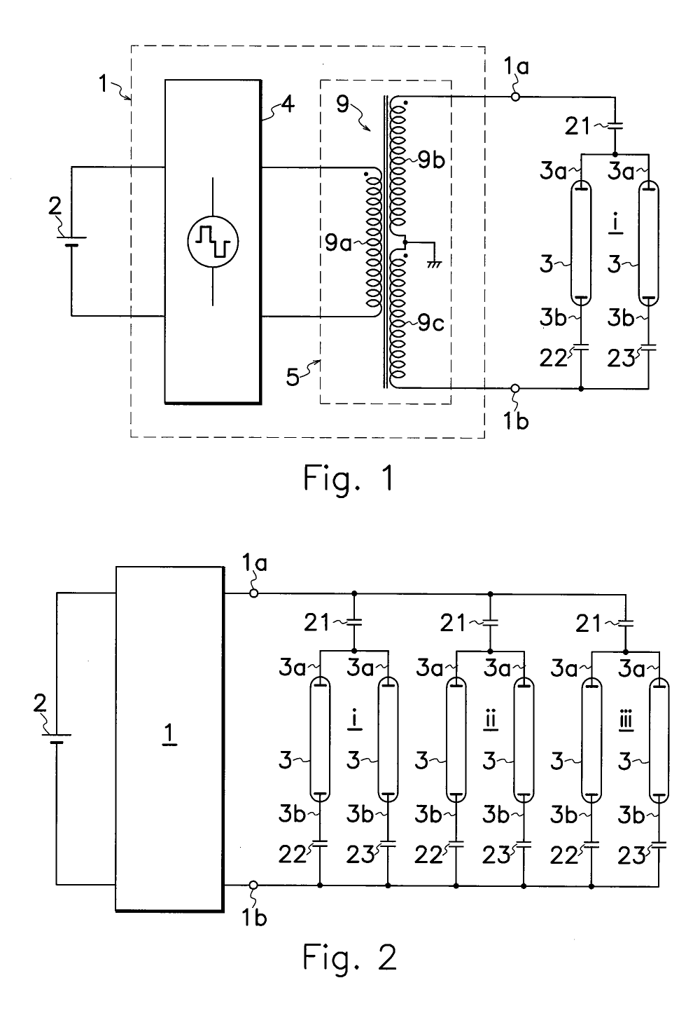

FIG. 2 illustrates a second embodiment of the present invention provided with three pairs (i) to (iii) of discharge tubes 3 each connected between first and second output terminals 1a and 1b of inverter 1. Each first terminal 3a of each pair (i) to (iii) of discharge tubes 3 is connected to first output terminal 1a of inverter 1 through a first ballast capacitor 21 which has the capacitance of for example 40 picofarads. Also, each second terminal 3b of each discharge tube 3 is connected to second output terminal 1b of inverter 1 through respectively and separately second and third ballast capacitors 22 and 23 which has the capacitance of for example individually 20 picofarads. Even in the circuit shown in FIG. 2, since second and third ballast capacitors 22 and 23 operate independently of each other, trigger voltage of sufficient level can be impressed on unlit discharge tubes 3 with reduced number of ballast capacitors 21 to 23 relative to number of discharge tubes, and the circuit can produce similar functions and effects to those in the circuit shown in FIG. 1.

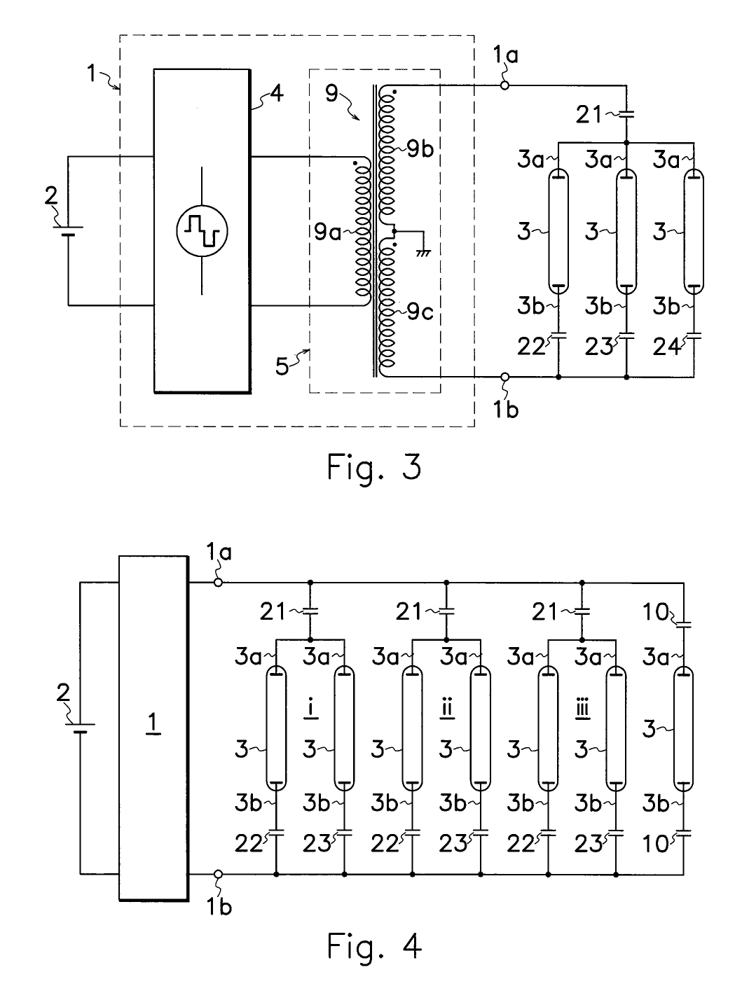

FIG. 3 shows a third embodiment of the cold cathode fluorescent lighting discharge tube device according to the present invention which comprises a trio of discharge tubes 3 each having a first terminal 3a connected to first output terminal 1a of inverter 1 through a common first ballast capacitor 21 and a second terminal 3b connected to second output terminal 1b of inverter 2 separately and respectively through second, third and fourth ballast capacitors 22, 23 and 24. The third embodiment shown in FIG. 3 requires first ballast capacitor 21 of relatively large capacitance, however, number of ballast capacitors 21 to 24 can be reduced relative to number of discharge tubes 3 because second, third and fourth ballast capacitors 22, 23 and 24 work independently of each other during operation, and trigger voltage of sufficient level can be applied to unlit discharge tube 3.

FIG. 4 demonstrates a fourth embodiment of the present invention which comprises three pairs (i) to (iii) of discharge tubes 3 and ballast capacitors 21 to 23 connected to discharge tubes 3 similarly to FIG. 2, a single odd discharge tube 3, in addition to three pairs (i) to (iii) of discharge tubes 3, and a pair of ballast capacitors 10 connecting first and second ends 3a and 3b of odd discharge tube 3 with respectively first and second output terminals 1a and 1b of inverter 1.

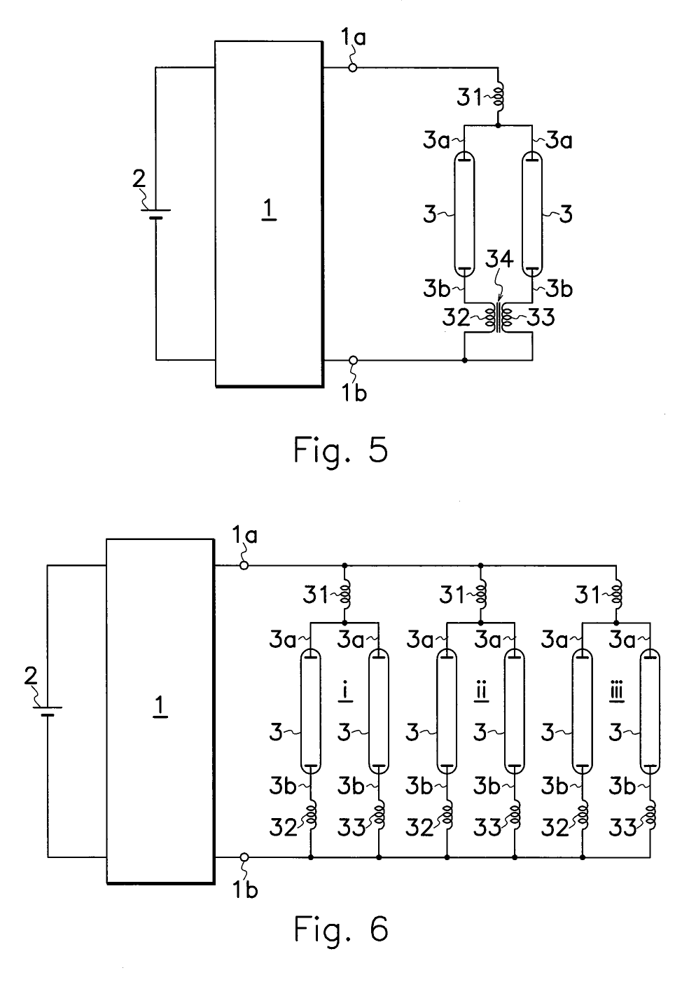

FIG. 5 shows a variation of the first embodiment shown in FIG. 1 which substitutes first, second and third ballast coils 31, 32 and 33 for first, second and third ballast capacitors 21, 22 and 23 in FIG. 1 and further adopt a common mode choke coil 34 comprised of second and third ballast coils 32 and 33 electromagnetically coupled to each other. In FIG. 5, as second and third ballast coils 32 and 33 separately can operate, start-up voltage of sufficient level can be supplied to inactivated discharge tube 3 with a reduced number of ballast coils 31 to 33 relative to number of discharge tubes 3. In the exemplified embodiment of FIG. 5, inductances of first, second and third ballast coils 31, 32 and 33 are respectively for example 0.5, 1 and 1 henry.

FIG. 6 exhibits a sixth embodiment of the present invention in a varied mode which substitutes first, second and third ballast coils 31, 32 and 33 for first, second and third ballast capacitors 21, 22 and 23 in the second embodiment shown in FIG. 2, and the sixth embodiment can perform similar functions and effects to those in the second embodiment. Inductances of first, second and third ballast coils 31, 32 and 33 are respectively for example 0.5, 1 and 1 henry.

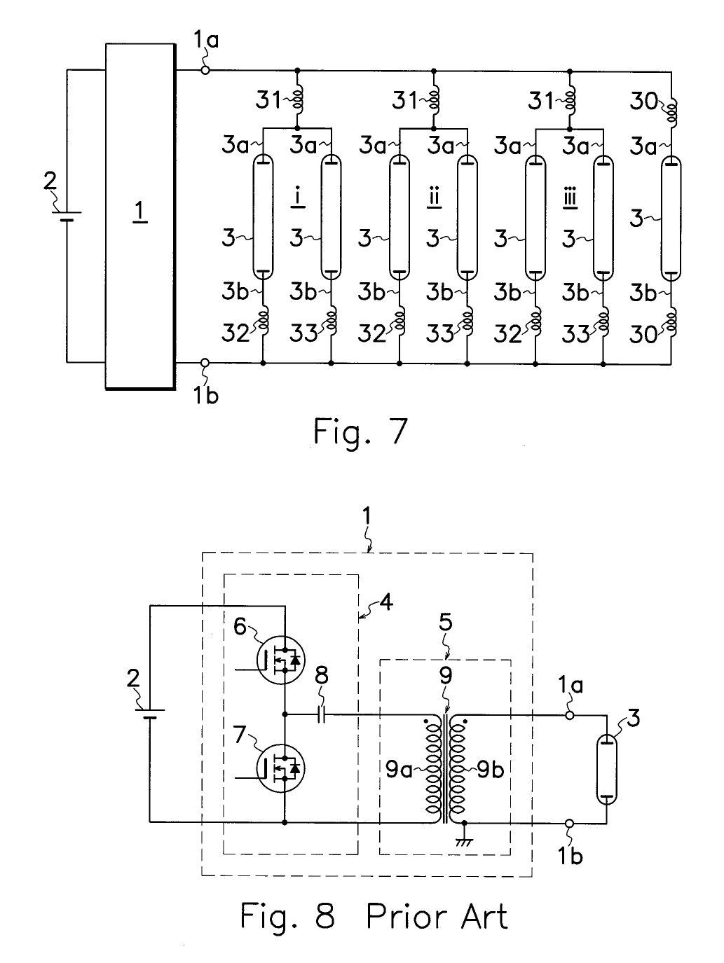

FIG. 7 represents a seventh embodiment of the present invention which adopts first, second and third ballast coils 31, 32 and 33 in place of first, second and third ballast capacitors 21, 22 and 23 in FIG. 4, a single odd discharge tube 3 in addition to three pairs (i) to (iii) of discharge tubes 3, and a pair of additional ballast coils 30 connected between each end of odd discharge tube 3 and first and second output terminals 1a and 1b in place of a pair of ballast capacitors 10 shown in FIG. 4. In the seventh embodiment, first, second and third ballast coils 31, 32 and 33 may have the same inductance value as those in FIG. 6, and each of additional ballast coils 30 may have an inductance of 1 henry. In any cases, each of first, second and third ballast capacitors 21, 22 and 23, ballast capacitors 10, first, second and third ballast coils 31, 32 and 33, and ballast coils 30 can store electric energy by virtue of electric current flowing therethrough and provide an impedance against the passing electric current. First, second and third ballast elements 21, 31, 22, 32, 23 and 33, and additional ballast elements 10 and 30 may preferably be one or more selected from the group of inductors such as capacitors, coils and choke coils. Inductors such as coils and choke coils have single or plural windings, and inductors such as coils and choke coils which have a plurality of windings to induce a coupled magnetic flux for defining a built-in or other type of mutual inductance.

The foregoing embodiments of the present invention may be varied and modified in various ways. For example, FIGS. 2, 4, 6 and 7 indicate three pairs (i) to (iii) of discharge tubes 3, instead, 4 or more pairs, namely n pairs of discharge tubes 3 may be connected between first and second output terminals 1a and 1b of inverter 1. Also, first to fourth ballast capacitors 21 to 24 shown in FIG. 3 may be replaced with first to fourth ballast coils. In addition, inactive standby time of unlit discharge tube 3 to the lighting can be reduced to a substantially shorter time or nearly zero if suitable values are selected from lighting start voltage of discharge tubes 3, output voltage of transformer 9, characteristics or constant of each ballast capacitors 21 to 23 and 10 or each ballast coils 31 to 33 and 30. Moreover, although the foregoing embodiments utilize an AC power generator 4 of half-bridge type, instead, it may utilize other generator such as full-bridge or push-pull type.

As above-mentioned, the present invention can reduce the number of ballast elements without reduction in performance of the cold cathode fluorescent lighting discharge tube device which can be made in small size, light weight and at inexpensive cost for manufacture. The present invention is effectively applicable to cold cathode fluorescent lighting tube devices having ballast elements.

What is claimed are:

1. A cold cathode fluorescent lighting discharge tube device comprising:
at least a pair of discharge tubes each having first and second ends,
an inverter for converting DC voltage from a DC power source into AC voltage, the inverter having first and second output terminals to apply AC voltage between first and second terminals of each discharge tube,
a first ballast element connected between each first end of the pair of the discharge tubes and first output end of the inverter,
a second ballast element connected between the second terminal of one of the pair of the discharge tubes and second output terminal of the inverter, and
a third ballast element connected between the second terminal of the other of the pair of the discharge tubes and second output terminal of the inverter.

2. The device of claim 1, further comprising a further single discharge tube in addition to the pair or plural pairs of the discharge tubes, and
a pair of ballast elements each connected between a first terminal of said single discharge tube and the first output terminal of the inverter and between a second terminal of the single discharge tube and the second output terminals of the inverter.

3. The device of claim 2, wherein the first, second and third ballast elements and the pair of ballast elements accumulate electric energy by electric current through each ballast element and provide an impedance against said electric current.

4. The device of claim 2 or 3, wherein each of the first, second and third ballast elements and the pair of ballast elements comprises one or ones selected from the group of capacitors and inductors.

5. The device of claim 4, wherein the inductor comprises a single or a plurality of windings,
the inductor of plural windings comprises mutual inductance of magnetic fluxes produced by each winding in the coupled relation to each other.
